(19) United States
(12) Patent Application Publication
(10) Pub. No.: US 2009/0044342 A1
(43) Pub. Date: Feb. 19, 2009

(54) Inflatable massaging mattress

(76) Inventor: Franco Cengarle, Trieste (IT)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 11/666,440

(22) PCT Filed: Oct. 31, 2005
(86) PCT No.: PCT/EP2005/011625

§ 371 Date: Apr. 27, 2007

(30) Foreign Application Priority Data
Oct. 29, 2004 (IT) UD2004A000203

(51) Int. Cl. A61H 23/04; A61H 1/00

(52) U.S. Cl. 5/711

(57) ABSTRACT

An inflatable massaging mattress, comprising: —an air compressor (16), —a cyclic distributor (14) for the air originating from said compressor (16), —a plurality n of flexible tubes (12₁-12₁₄) connected to said distributor, —a flexible sheet (2) of air-impermeable plastic material onto which a second sheet (6) is welded along longitudinal lines (4) to form n conduits (8₁-8₁₄) closed at one end (10), each conduit (8₁-8₁₄) being connected at its other end to one of said tubes (12₁-12₁₄), —m groups of n mutually adjacent but separated air chambers disposed transverse to the axis of the sheets, each conduit (8₁-8₁₄) being connected to one of the n air chambers (20) of each of the m groups by washers (24) of heat-activatable glue.

The present invention relates to an inflatable massaging mattress.

Massaging mattresses are known applicable to a bed, chair, armchair or the like, comprising a plurality of compressed air-inflatable air chambers of substantially rectangular shape disposed joined together adjacent to each other to define a support surface for the user.

The air chambers are connected via tubes to a rotary compressed air distributor fed by a compressor operated by an electric motor.

A mattress of this type is described for example in the European patent No. 0844863.

This mattress has proved however susceptible to improvement with regard to the arrangement of its constituent elements, in order to provide it with a shape substantially more contained in thickness, and to enable it to circulate air between the chambers to ventilate the user.

According to the invention, this improvement is obtained by an inflatable massaging mattress as described in claim 1.

The present invention is described in detail hereinafter with reference to the accompanying drawings, in which:

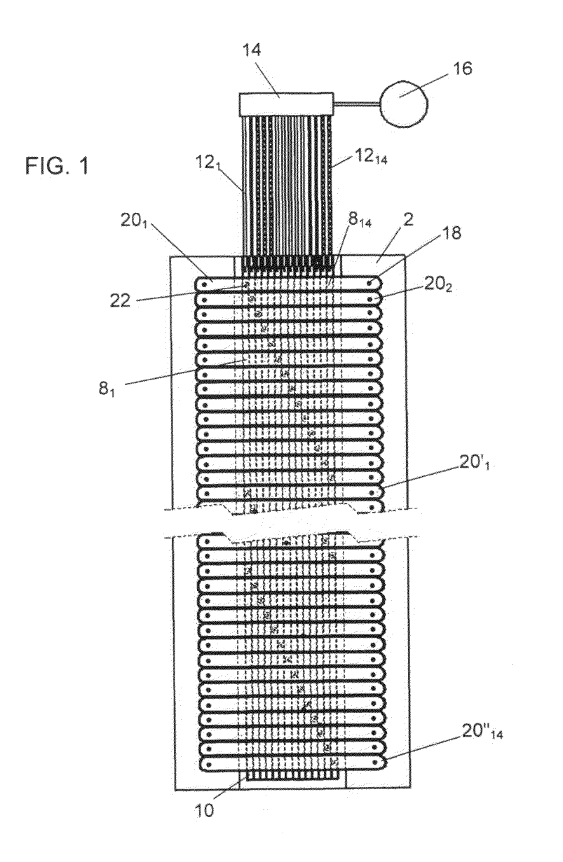

FIG. 1 is a plan view of an inflatable massaging mattress according to the invention,

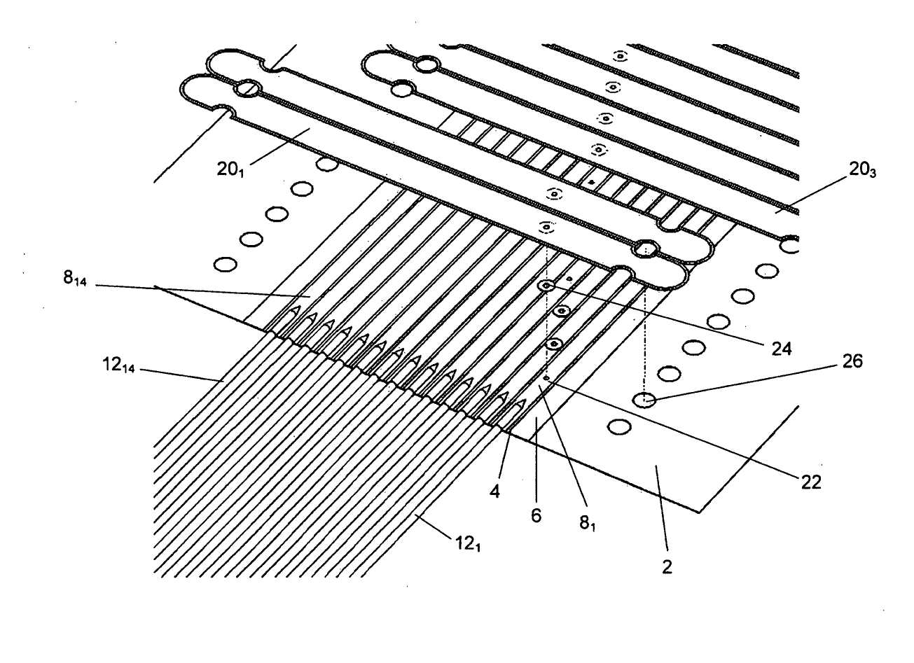

FIG. 2 is an enlarged exploded view in its non-inflated state, and

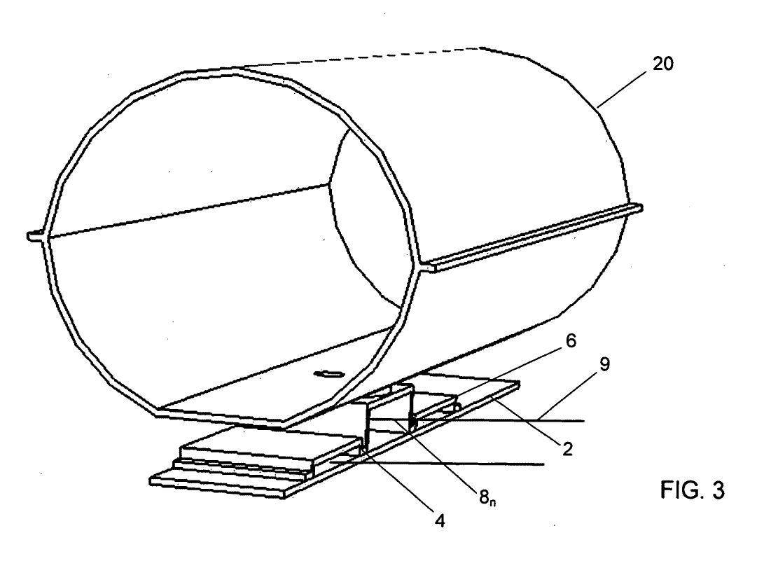

FIG. 3 is an enlarged detailed view of the connection between the sheets and the air chambers.

As can be seen from the figures, the mattress of the invention comprises substantially a first rectangular sheet 2 of flexible air-impermeable material, for example pvc, of dimensions suitable to receive a person lying outstretched, for example 50 cm×190 cm.

A second rectangular sheet 6, of characteristics identical to the first sheet but of smaller dimensions, is joined to the sheet 2 along longitudinal welding lines 4, to form a plurality of longitudinal channels 8₁-8₁₄ (fourteen in the illustrated example) closed at one end 10 and open at the other end into which corresponding flexible tubes 12₁-12₁₄ are inserted.

Within the longitudinal channels 8₁-8₁₄ there is disposed a nylon thread 9 (or a suitable projection on the sheet) of diameter between 0.2 and 1.5 mm, its purpose being to enable compressed air to flow into the conduit even if constrictions are present due to the arrangement of the mattress on an armchair or to the weight of the user.

The tubes 12₁-12₁₄ are connected to a rotary compressed air distributor 14 connected to a compressor 16 to feed air at a determined pressure to the mattress.

A plurality (three in the illustrated example) of groups of air chambers 20 disposed transversely to the axis of the sheets are hot-glued to the sheet 2 at points 18.

Said air chambers are of rectangular plan shape, they are formed of air-impermeable flexible material and are disposed one adjacent to but separated from another to form a rectangular support surface for the user. The fact that they are separated enables a chamber, by not being retained by the adjacent chamber, to completely expand during inflation, with a much more perceptible effect on the user.

Specifically, in the illustrated example, each group comprises fourteen flat air chambers obtained by welding, each air chamber 20 of each group being connected to one of the fourteen longitudinal channels 8₁-8₁₄ via an aperture 22. The air chamber is joined to the channel by interposing a washer 24 of heat-activatable adhesive or other similar material.

More specifically, the longitudinal channel 8₁ is joined to the air chambers 20₁, 20′₁ and 20″₁, the longitudinal channel 82 is joined to the air chambers 20₂, 20′₂ and 20″₂, and so on.

The mattress of the invention comprises a plurality of substantially vertical and variously positioned through apertures 26 of various shapes and sizes which connect that surface facing the user to that surface resting on the chair or bed.

In the illustrated example the apertures 26 are circular in shape and are provided through the two sheets and through the air chamber portions which lie above them.

The apertures can also be of rectangular or slotted cross-section, and be of chequered arrangement.

The mattress operates in the following manner.

On operating the compressor 16 the distributor 14 cyclically connects the compressor delivery to one of the tubes 12₁-12₁₄ and then feeds air into the conduits 8₁-8₁₄. As a result of the connection between said longitudinal channels 8₁-8₁₄ and the air chambers 20₁-20₁₄, the compressed air generated by the compressor is transmitted cyclically to the successive air chambers, causing them to temporarily inflate and give rise to a plurality of waves (three, as they correspond to the different groups) which travel from one end of the cushion to the other.

In a variant, not shown in the drawings, instead of being connected to those air chambers 20₁ of each group which are closest to that end of the sheets into which the tubes 12₁-12₁₄ are inserted, the channel 8₁ is connected to that air chamber of a group which is the most distant of the air chambers of that group from the tubes 12₁-12₁₄, to create two waves which advance in mutual opposition.

From the aforegoing it is apparent that the inflatable mattress according to the invention has the advantage of a substantially more contained shape by virtue of the arrangement of the channels 8₁-8₁₄ in a position below the air chambers and also enables the user to be effectively ventilated.

1. An inflatable massaging mattress, comprising:
an air compressor,
a cyclic distributor for the air originating from said compressor,
a plurality n of flexible tubes connected to said distributor,
a first and a second flexible sheet of air-impermeable plastic material said sheets being welded to each other to form n longitudinal ducts closed at one end, each of said n ducts being connected at its other end to one of said n tubes each duct being provided with an opening,
m groups of n parallel adjacent but separated air chambers disposed transverse to the axis of the ducts, each air chamber being provided with an opening faced to the opening of one duct,
a washer of heat activated adhesive interposed between said openings of the chambers and ducts,
the connection between the flexible tubes of the distributor and the closed ducts and between the closed ducts and the air chambers allowing a temporary and successive inflation of the n air chambers or one or more of the m groups.

2. A mattress as claimed in claim 1, wherein the air chambers, when deflated, are of rectangular plan shape.

3. An inflatable mattress as claimed in claim 1, further comprising a plurality of through apertures which connect together the outer surfaces of the two sheets.

4. An inflatable mattress as claimed in claim 3, wherein the apertures are of substantially circular shape and are provided both through the sheets and through those air chamber portions which overlie said sheets.

5. An inflatable mattress as claimed in claim 3, wherein the apertures are of rectangular cross-section.

6. An inflatable mattress as claimed in claim 3, wherein the apertures are of slotted cross-section.

7. An inflatable mattress as claimed in claim 3, wherein the apertures are of chequered arrangement.
